(19) United States
(12) Patent Application Publication
(10) Pub. No.: US 2026/0304522 A1
(43) Pub. Date: Oct. 1, 2026

(54) SUPPORT OF MULTIPLE UP CONNECTIONS

(71) Applicant: QUALCOMM Incorporated, San Diego, CA (US)

(72) Inventors: Hong CHENG, Basking Ridge, NJ (US); Sunghoon KIM, San Diego, CA (US); Lenaig Genevieve CHAPONNIERE, La Jolla, CA (US); Hanna LIM, Seongnam-si (KR); Miguel GRIOT, La Jolla, CA (US)

(21) Appl. No.: 19/554,076

(22) Filed: Mar. 2, 2026

Related U.S. Application Data
(60) Provisional application No. 63/779,945, filed on Mar. 28, 2025.

(51) Int. Cl. H04W 76/15; H04W 64/00

(52) U.S. Cl. CPC H04W 76/15; H04W 64/00

(57) ABSTRACT

Apparatus, methods, and computer program products for wireless communication are provided. An example method may include transmitting a capability indication indicating that the UE supports multiple user plane (UP) connections associated with a same network entity type. The example method may further include receiving a non-access stratum (NAS) message including UP information associated with a second network entity, where the UE has a first UP positioning connection session context associated with a first network entity, the first network entity and the second network entity being associated with the same network entity type. The example method may further include establishing a second UP connection with the second network entity based on the received NAS message.

### CROSS REFERENCE TO RELATED APPLICATION(S)

The present application for patent claims priority under 35 U.S.C. § 119 to U.S. Provisional Patent Application No. 63/779,945, filed Mar. 28, 2025 and entitled “SUPPORT OF MULTIPLE UP CONNECTIONS,” which is assigned to the assignee hereof and hereby expressly incorporated by reference herein in its entirety.

### TECHNICAL FIELD

The present disclosure relates generally to communication systems, and more particularly, to wireless communication systems with user plane (UP) connections.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) transmit a capability indication indicating that the UE supports multiple user plane (UP) connections associated with a same network entity type. Based at least in part on information stored in the at least one memory, the at least one processor, individually or in any combination, is configured to receive a non-access stratum (NAS) message including UP information associated with a second network entity, where the UE has a first UP positioning connection session context associated with a first network entity, the first network entity and the second network entity being associated with the same network entity type. Based at least in part on information stored in the at least one memory, the at least one processor, individually or in any combination, is configured to establish a second UP connection with the second network entity based on the received NAS message.

In another aspect of the disclosure, a method, a computer-readable medium, and an apparatus at an access and mobility management function (AMF) are provided. The apparatus may include at least one memory and at least one processor coupled to the at least one memory. Based at least in part on information stored in the at least one memory, the at least one processor, individually or in any combination, is configured to receive a capability indication associated with a user equipment (UE) indicating that the UE supports multiple user plane (UP) connections associated with a same network entity type. Based at least in part on information stored in the at least one memory, the at least one processor, individually or in any combination, is configured to receive a first message to initiate a UP positioning connection session for the UE, where the UE has a current UP positioning connection session context. Based at least in part on information stored in the at least one memory, the at least one processor, individually or in any combination, is configured to transmit, based on the capability indication and after reception of the first message to initiate the UP positioning connection session, a location configuration request (e.g., UP positioning connection configuration request) to the UE.

In another aspect of the disclosure, a method, a computer-readable medium, and an apparatus at an access and mobility management function (AMF) are provided. The apparatus may include at least one memory and at least one processor coupled to the at least one memory. Based at least in part on information stored in the at least one memory, the at least one processor, individually or in any combination, is configured to receive, from a source network entity with a user plane (UP) connection associated with a user equipment (UE), a notification message including information of a target network entity associated with a same network entity type as the source network entity. Based at least in part on information stored in the at least one memory, the at least one processor, individually or in any combination, is configured to transmit, based on the notification message, a location configuration request (e.g., UP positioning connection configuration request) to the source network entity to indicate a request for a change to the target network entity.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example communications between a UE, a radio access network (RAN), an access and mobility management function (AMF), a user plane function (UPF), and a location management function (LMF), in accordance with various aspects of the present disclosure.

FIG. 5 is a diagram illustrating example communications between a UE, a RAN, an AMF, a UPF, and an LMF, in accordance with various aspects of the present disclosure.

FIG. 6 is a diagram illustrating example communications between a UE, an AMF, a source LMF, and a target LMF, in accordance with various aspects of the present disclosure.

FIG. 7 is a diagram illustrating example communications between a UE, an AMF, a source LMF, and a target LMF, in accordance with various aspects of the present disclosure.

FIG. 8A is a diagram illustrating an example structure with a UE, an AMF, a first LMF, a second LMF, and a third LMF, in accordance with various aspects of the present disclosure.

FIG. 8B is a diagram illustrating an example structure with a UE, an AMF, a first LMF, and a second LMF, in accordance with various aspects of the present disclosure.

FIG. 8C is a diagram illustrating an example structure with a UE, an AMF, a first LMF, a second LMF, and a third LMF, in accordance with various aspects of the present disclosure.

FIG. 9 is a diagram illustrating example communications between a UE, an AMF, a source LMF, and a target LMF, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity, in accordance with various aspects of the present disclosure.

FIG. 14 is a diagram illustrating an example of a hardware implementation for a network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Example aspects herein may facilitate management of multiple user plane (UP) connections associated with a same type of network entity (such as a location management function (LMF) or a management function for integrated sensing and communication (ISAC), or a management function for other types of non-data communication based services) for a single user equipment (UE), which may be an enhancement that improves positioning performance, sensing operations, or other non-data communication based services for UEs.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

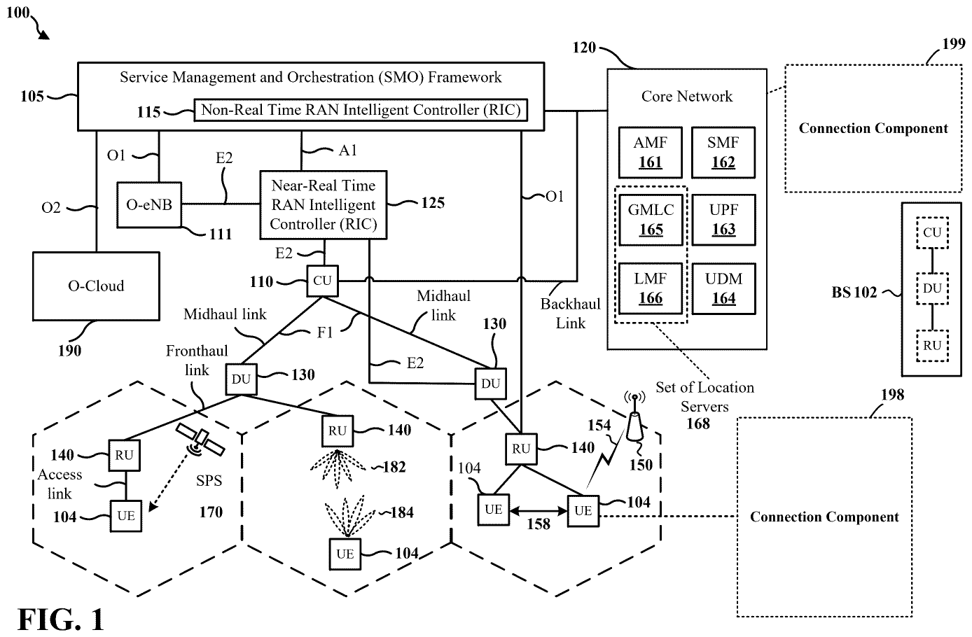

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHZ-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. Another entity that may support the one or more location servers 168 may be a management function associated with an integrated sensing and communication (ISAC). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a connection component 198. In some aspects, the connection component 198 may be configured to transmit a capability indication indicating that the UE supports multiple UP connections associated with a same network entity type. In some aspects, the connection component 198 may be further configured to receive a non-access stratum (NAS) message including UP information associated with a second network entity, where the UE has a first UP positioning connection session context associated with a first network entity, the first network entity and the second network entity being associated with the same network entity type. In some aspects, the connection component 198 may be further configured to establish a second UP connection with the second network entity based on the received NAS message. In some aspects, the first network entity and the second network entity may be of different sub-types, e.g., offering some different type of services to the UE. For example, the first network entity may offer some location methods that is different from those offered by the second network entity.

In certain aspects, the core network 120, such as a management function (e.g., the AMF 161 within the core network 120) may include a connection component 199. In some aspects, the connection component 199 may be configured to receive a capability indication associated with a UE indicating that the UE supports multiple UP connections associated with a same network entity type. In some aspects, the connection component 199 may be further configured to receive a first message to initiate a UP positioning connection session for the UE, where the UE has a current UP positioning connection session context, either stored locally in the AMF 161 or another AMF, or a database of the mobile network, e.g. UDM or UDR. In some aspects, the connection component 199 may be further configured to transmit, based on the capability indication and after reception of the first message to initiate the UP positioning connection session, a location configuration request (e.g., UP positioning connection configuration request) to the UE. In some aspects, the transmission of the message to initiate the UP positioning connection session may be forwarded to the UE via the base station 102.

In some aspects, the connection component 199 may be configured to receive, from a source network entity, e.g. a source LMF, with a UP connection associated with a UE, a notification message including information of a target network entity associated with a same network entity type as the source network entity, e.g. a target LMF identification. In some aspects, the connection component 199 may be further configured to transmit, based on the notification message, a location configuration request, e.g. UP positioning connection configuration request, to the source network entity, e.g. the source LMF, to indicate a request for a change to the target network entity, e.g. the target LMF. The request contains the identifier of the target network entity.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

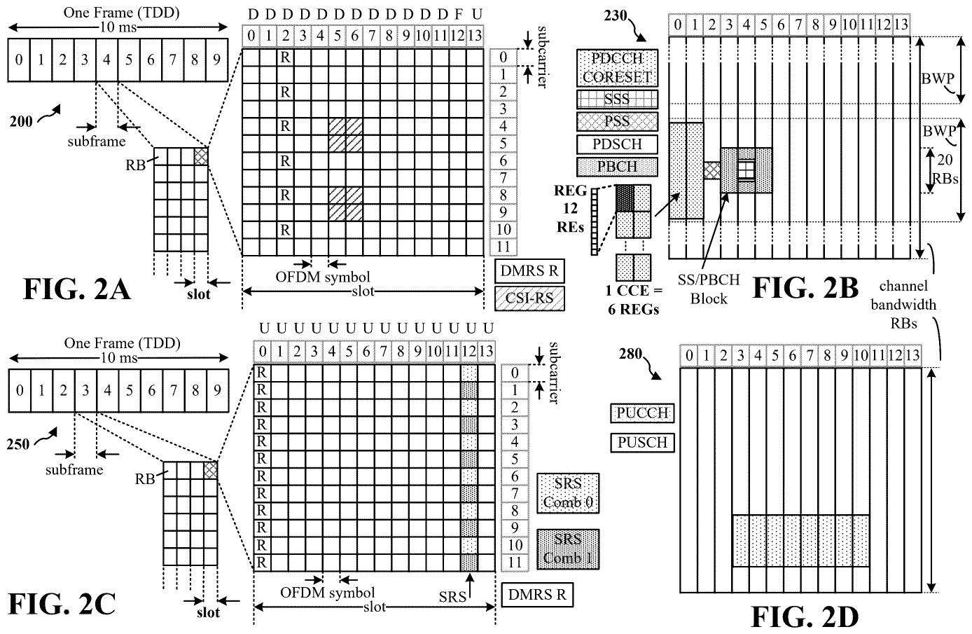

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

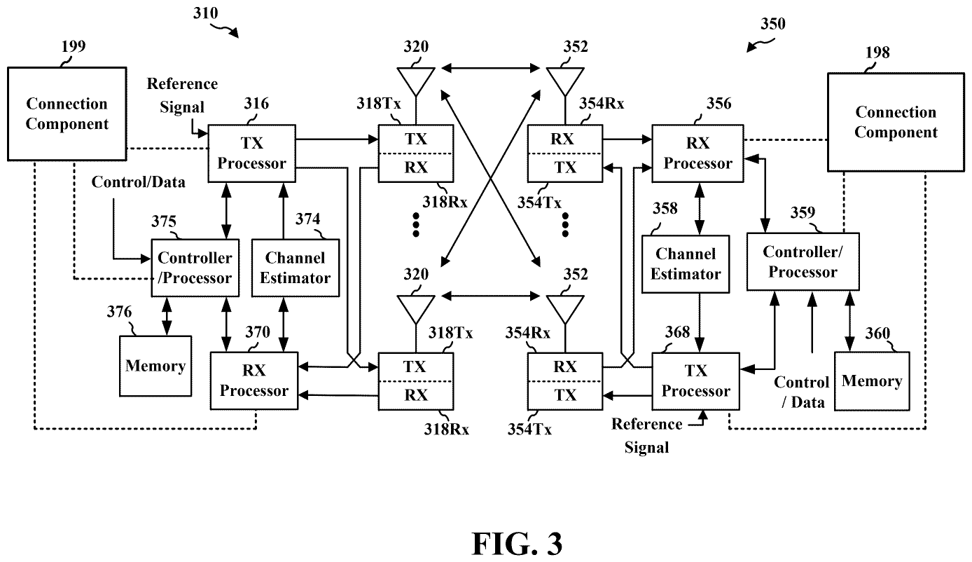

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with connection component 198 of FIG. 1.

At least one of the TX processor 316, the RX processor 370, and the controller/processor 375 may be configured to perform aspects in connection with connection component 199 of FIG. 1.

In some wireless communication systems, a single (e.g., one and no more than one) simultaneous location service (LCS)-UP (LCS-UP) connection per UE may be supported. Example aspects herein may facilitate management of multiple simultaneous UP connections associated with a same type of network entity (such as a LMF or a management function for ISAC, or a management function for other type of non-data communication based services) for a single UE, which may be an enhancement that improves positioning performance for UEs. Example aspects may relate to enforcement of a single (e.g., no more than one) LCS-UP connection for UEs that do not support multiple LCS-UP connections. Example aspects may also relate to handling of network entity (e.g., LMF) change procedures for UEs that support multiple LCS-UP connections.

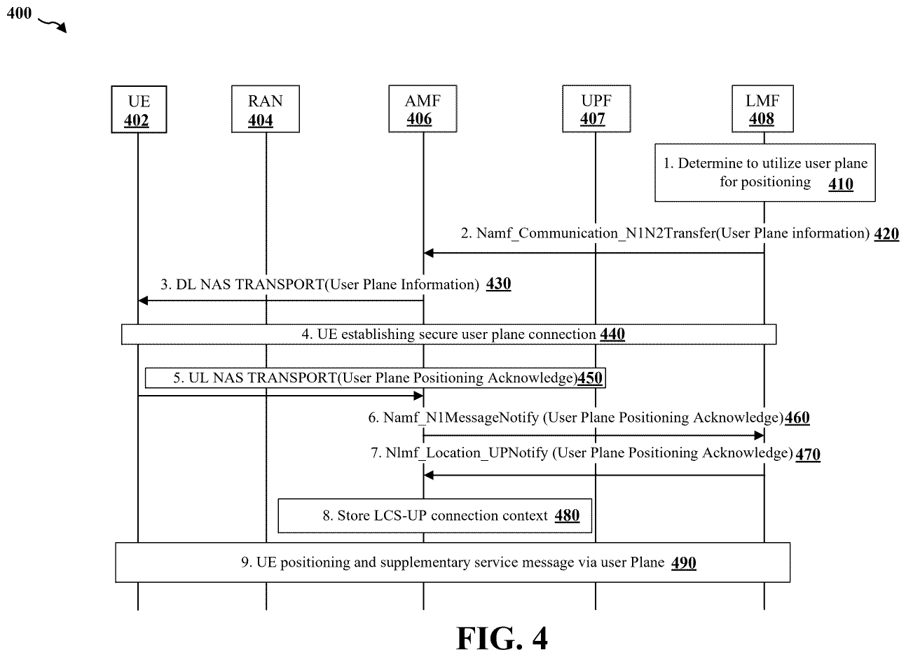

FIG. 4 is a diagram 400 illustrating example communications between a UE 402, a RAN 404, an AMF 406, a UPF 407, and an LMF 408, in accordance with various aspects of the present disclosure. At 410, the LMF 408 may determine to utilize user plane for positioning (e.g., decides that UP positioning is appropriate for a current session associated with the UE 402 (based on UE capability, policy, load, or the like)). After the determination at 410, the LMF 408 may transmit UP information 420 to the AMF 406 in a request to establish connection with the UE 402. The UP information 420 may include address information (e.g., IP address, port, FQDN, or the like), security parameters, or other information related to the LMF 408 that may facilitate a connection to the LMF 408, e.g. a UP connection binding ID. Upon receiving the UP information 420, the AMF 406 may include the UP information 420 in an NAS message 430 to the UE 402 (e.g., via the RAN 404). Upon receiving the NAS message 430, the UE 402 may, at 440, establish a secure UP connection with the LMF 408. The UP connection may carry positioning protocol messages to facilitate positioning for the UE. The UE 402 may also transmit an UL NAS message 450 which may include a UP positioning acknowledge to indicate successful establishment of the connection at 440, and to allow the LMF 408 to bind the UP connection with the corresponding UE and location service sessions. Upon receiving the UL NAS message 450, the AMF 406 may transmit a notification message 460 to inform the LMF 408 about the UP positioning acknowledge. Upon receiving the notification message 460, the LMF 408 may respond with a notification message 470 that acknowledges the reception of the UP positioning acknowledge originated from the UE 402. Upon receiving the notification message 470 that acknowledges the reception of the UP positioning acknowledge originated from the UE 402, the AMF 406 may store, at 480, LCS-UP connection context associated with the UE (e.g., which indicates that the UE currently has a UP connection with the LMF 408). At 490, UE positioning may be performed and supplementary service messages may be communicated via UP.

If the UE 402 does not support (e.g., or does not indicate to support) multiple UP connections for a same network entity, the AMF 406 may determine that the LMF 408 is a new LMF for the UE 402 by receiving the message that includes the UP information 420 from the LMF, which includes a container (e.g., a UP positioning connection management information (UPP-CMI)), and may reject the request to establish connection with the UE 402, if the UE 402 did not include such an indication in its capabilities that indicates the UE supports multiple UP connections with LMFs. The UE 402 may have included the capability indication in a registration request to the AMF 406. Alternatively, the AMF 406 may have received the capability indication as part of the UE context from another AMF or MME when a mobility event happened for the UE 402. In some aspects, the AMF 406 may reject the request if: (1) the UE does not support multiple UP connections and the UE already has a UP connection or (2) the LMF is not an LMF involved in a LMF change procedure or (3) the AMF is configured to not allow multiple UP connections to the same type of network entities for a UE. In some aspects, before 410, the UE 402 may have transmitted a capability indication that indicates whether the UE supports multiple UP connection associated with a same network entity type. In some aspects, if the AMF 406 rejects the request, the AMF may include a cause code to indicate the reason for the rejection.

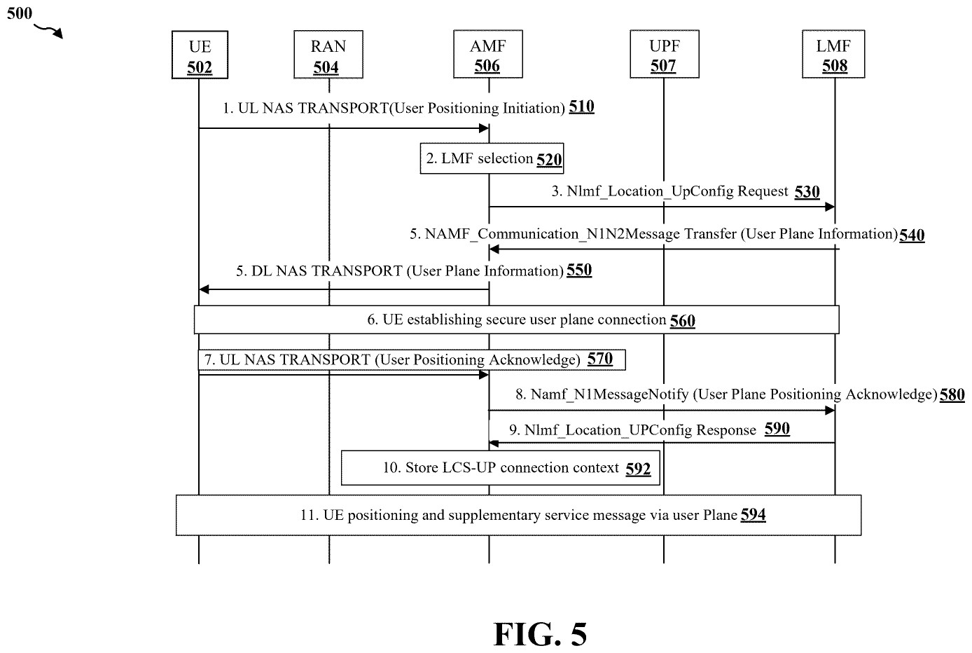

FIG. 5 is a diagram 500 illustrating example communications between a UE 502, a RAN 504, an AMF 506, a UPF 507, and an LMF 508, in accordance with various aspects of the present disclosure. As illustrated in FIG. 5, the UE 502 may transmit an UL NAS message 510 which indicates an UP positioning connection initiation (to initiate a UP positioning connection session) to the AMF 506. Upon receiving the UL NAS message 510 which indicates the UP positioning connection initiation, the AMF 506 may select a suitable LMF at 520 based on previously receiving a capability indication indicating that the UE 502 supports multiple UP connections with a same network entity type if the UE 502 has UP connection context, e.g. LCS-UP connection context, or based on the UE 402 does not have LCS-UP connection context. If the UE 502 has an LCS-UP connection context and the AMF 506 has not received a capability indication indicating that the UE 502 supports multiple UP connections with a same network entity type, the AMF 506 may reject the UP positioning connection initiation instead. After selecting a suitable LMF at 520, the AMF 506 may transmit a location configuration request (e.g., UP positioning connection configuration request) 530 to the selected LMF 508 and may receive UP information 540 from the LMF 508, which may include information such as IP address, port, security information, or the like. The AMF 506 may transmit a DL NAS message 550 that includes the UP information 540 to the UE 502 (e.g., via the RAN 504). Upon receiving the NAS message 550, the UE 502 may, at 560, establish a secure UP connection with the LMF 508. The UP connection may carry positioning protocol messages to facilitate positioning for the UE. The UE 502 may also transmit an UL NAS message 570 which may include a UP positioning acknowledge to indicate successful establishment of the connection at 440. Upon receiving the UL NAS message 570, the AMF 506 may transmit a notification message 580 to inform the LMF 508 about the UP positioning acknowledge. Upon receiving the notification message 580, the LMF 508 may respond with a notification message 590 that acknowledges the reception of the UP positioning acknowledge originated from the UE 502. Upon receiving the notification message 590 that acknowledges the reception of the UP positioning acknowledge originated from the UE 502, the AMF 506 may store, at 592, LCS-UP connection context associated with the UE (e.g., which indicates that the UE currently has a UP connection with the LMF 508). At 594, UE positioning may be performed and positioning messages or supplementary service messages may be communicated via UP.

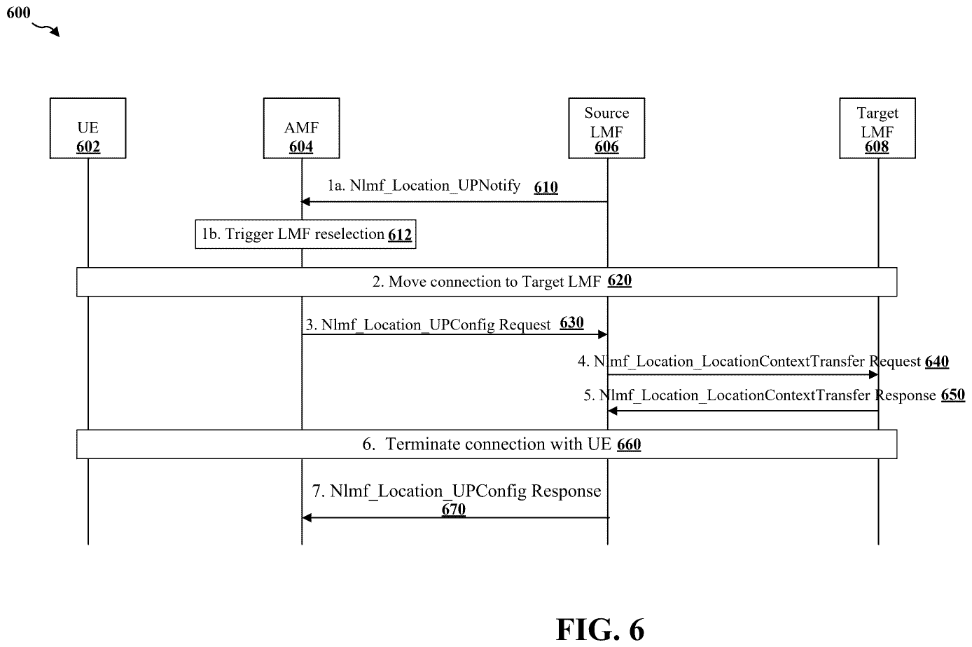

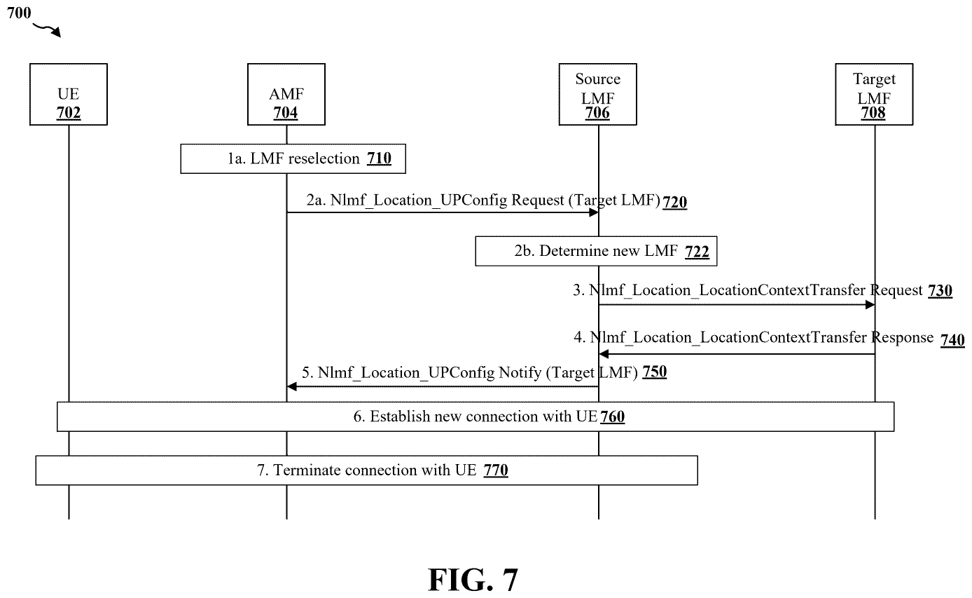

FIG. 6 is a diagram 600 illustrating example communications between a UE 602, an AMF 604, a source LMF 606, and a target LMF 608, in accordance with various aspects of the present disclosure. As illustrated in FIG. 6, the source LMF 606 may transmit a notification message 610 to the AMF 604 to indicate that triggering conditions for LMF reselection or indicate the LMF reselection associated with a current UP session with the UE 602. At 612, after receiving the notification message 610, the AMF 604 may trigger an LMF reselection. In some wireless communication systems, after the AMF 604 triggers the LMF reselection, there may be attempts to move the UP connection of the UE 602 to the target LMF 608 and disable the UP connection with the source LMF 606, even if the target LMF 608 does not yet have information about the UE 602. After the UP connection change, the source AMF 604 may transmit a location configuration request (e.g., UP positioning connection configuration request) 630 to the source LMF 606 so that the source LMF 606 may forward the UE context transfer information in a UE context transfer request message 640 to the target LMF 608. The UE context transfer information may include session information, UE-specific data, positioning state, and/or other information related to the UE 602. Upon receiving the UE context transfer request message 640, the target LMF 608 may transmit a UE context transfer response message 650 to the source LMF 606 to indicate a confirmation or a rejection of the transfer. If the UE context transfer response message 650 indicates a confirmation, the source LMF 606 may terminate connection with the UE 602 at 660 and transmit a location configuration response 670 to indicate the transfer. In some cases, the target LMF 608 may also indicate a rejection of the transfer, and the transfer may fail, which may result in additional handling in a control plane to process the failure (e.g., because the UE 602 may have already moved the UP connection at 620). Therefore, in some aspects, step 620 may be moved to be before or after the UE context transfer response message 650 and may be based on the UE context transfer response message 650 indicating a confirmation to avoid some error cases. An alternative operation that does not incur such errors is presented in FIG. 7.

FIG. 7 is a diagram 700 illustrating example communications between a UE 702, an AMF 704, a source LMF 706, and a target LMF 708, in accordance with various aspects of the present disclosure. At 710, the AMF 704 may determine to trigger LMF selection for the UE 702, which may be based on a notification message from the source LMF 706 or UE mobility associated with the UE 702 (e.g., while the UE is in a RRC connected mode or RRC idle mode). In some aspects, the AMF may also transmit a location configuration request (e.g., UP positioning connection configuration request) 720 to the source LMF 706 to indicate a request for changing LMF for the UE 702. Upon receiving the location configuration request 720, the source LMF 706 may determine the target LMF to be target LMF 708 at 722. After determining the target LMF 708 at 722, the source LMF 706 may transmit a UE context transfer request message 730 to the target LMF 708. The UE context transfer information may include session information, UE-specific data, positioning state, or other information related to the UE 702. The LMF change may be facilitated by the UE's change in mobility or based on the UE's UP event report.

Upon receiving the UE context transfer request message 730, the target LMF 708 may transmit a UE context transfer response message 740 to the source LMF 706 to indicate confirmation or rejection of the transfer. The source LMF 706 may transmit a location configuration response 750 to indicate information of the target LMF 708 (e.g., which may indicate an identifier (ID) of the target LMF 708) and to indicate the AMF 704 to release context associated with the source LMF 706. If the location configuration response 750 indicates confirmation, the AMF 704 may notify the UE 702 about the confirmation and the UE 702 may establish connection with the target LMF 708 at 760. After the UE 702 establishes connection with the target LMF 708 at 760, in aspects where some steps (e.g., 710, 720, 730, or 740) may be skipped, the source LMF 706 may terminate connection with the UE 702 at 770. In some aspects, one or more of the location configuration response 750 or the UE context transfer request message 730 may include a timer. For example, the target LMF 708 may attempt to complete the new UP connection establishment with UE 770 before the timer expires. In some other aspects, the AMF 704 may consider the Target LMF 708 has determined to not use UP connection if the connection establishment is not completed before the timer expires, e.g., AMF 704 has not received the Nlmf_Location_UPNotify as in 470 from the Target LMF 708. In that case, the AMF 704 would remove the UP connection context from the UE 702's UE context, and allows other LMFs to establish UP connections.

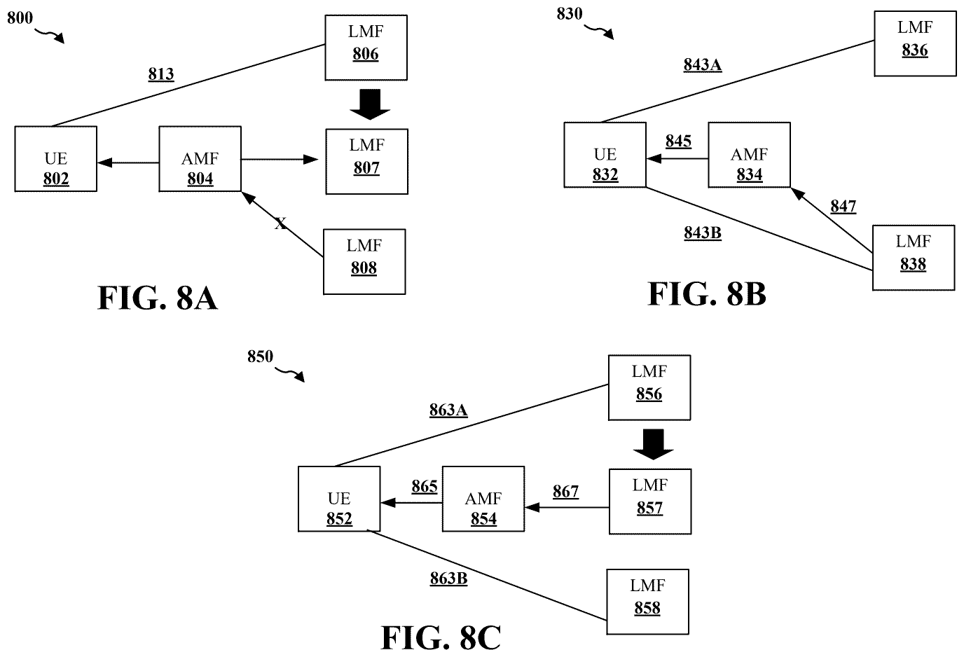

FIG. 8A is a diagram 800 illustrating an example structure with a UE 802, an AMF 804, a first LMF 806, a second LMF 807, and a third LMF 808, in accordance with various aspects of the present disclosure. In a scenario where the first LMF 806 or the AMF 804 decides to move an LCS session 813 associated with the first LMF 806 to the second LMF 807 using the procedure as illustrated in FIG. 6 or 7, there may be a third LMF 808 that may be requesting to establish UP connection with the UE 802 (e.g., because the third LMF 808 may be serving the UE 802 in a control plane). The first LMF 806 may inform the AMF 804 regarding the request from the second LMF 807 in a notification message. For a configured time period (e.g., based on a timer configured on the AMF, or signaled from the first LMF 806), the AMF may allow a request to be sent by the second LMF 807 to the UE 802 to go through and not allow request sent by other LMFs, including the third LMF 808. The third LMF 808 may be allowed to set up the UP and connect with the UE 802 if the second LMF 807 choose to not set up the UP connection with the UE 802 within the configured time period (e.g., AMF 804 released context after the timer expired). In some aspects, the AMF 804 may hold the request from the third LMF 808 until timer for the second LMF 806's UP connection with the UE 802 is expired, then forward the request. In some aspects, the AMF 804 may reject the request with a cause code indicating to the third LMF 808 the reason for the rejection, and/or a timer for the LMF 808 to re-attempt to connection establishment after the timer expiration. In some aspects, the AMF 804 may reject the request from the third LMF 808 first, and transmit a location configuration request (e.g., UP positioning connection configuration request) message to the third LMF 808 to facilitate the UP connection between the third LMF 808 and the UE 802 after the timer expires (e.g., and/or after the previous UP context is released). In some aspects, the AMF 804 performs the above control when it is configured to allow a single (e.g., one and no more than one) UP connection to the UE 802 for one type of network entities, or the capability indication from the UE 802 does not support multiple UP connections to the same type of network entities.

FIG. 8B is a diagram 830 illustrating an example structure with a UE 832, an AMF 834, a first LMF 836, and a second LMF 838, in accordance with various aspects of the present disclosure. As illustrated in FIG. 8B, the UE 832 may have one LCS-UP connection 843A with the first LMF 836, e.g., established using procedure as described in FIG. 4 or FIG. 5, and the AMF 834 may decide to use the second LMF 838 due to different LCS session, region, method or algorithm support. If the UE 832 has previously indicated capability of supporting multiple UP connections with a same network entity type, and if the AMF 834 supports, the AMF 834 may allow multiple-LCS-UP established for the UE 832. The AMF 834 may transmit a request to the second LMF 838 and receive a signaling 847 from the second LMF 838 confirming that the second LMF 838 may establish the UP connection with the UE 832, e.g., using procedure as illustrated in FIG. 5. In some aspects, the second LMF 838 may also decide that it is to establish an LCS-UP connection with the UE 832, e.g., using procedure as illustrated in FIG. 4. The AMF would allow the request to forwarded to the UE 832. In some aspects, to enable the UE 832 to differentiate between the LCS-UP connection 843A with the first LMF 836 and the LCS-UP connection 843B with the second LMF 838 that would be established, the AMF 834 may include a unique LMF identifier (ID) associated with the second LMF 838 in an NAS 845 to the UE 832 for establishment of the LCS-UP connection 843B with the second LMF 838. In some aspects, the LMF ID may be a universally unique ID (UUID). In some aspects, the LMF ID of the second LMF 838 may be generated by the second LMF 838 (e.g., and indicated in the signaling 847 that would be forwarded to the UE 832). In some aspects, the LMF ID of the second LMF 838 may be generated by the AMF 834. In such aspects, the AMF 834 may generate the LMF ID of the second LMF 838 in a fashion that would result in global uniqueness of the LMF ID. In some aspects, the LMF ID is provided to the UE 832, as part of the procedure for establishing the LCS-UP connection e.g., step 3 (430) of FIG. 4, or step 5 (550) of FIG. 5. In some aspects, the AMF 834 may generate and provide an LMF ID for the first LMF 836 when the LCS-UP connection 843A is established, e.g., using procedure as illustrated in FIG. 4 or 5.

In some aspects, to facilitate the UE 832 to associate the LCS sessions with the corresponding UP connection, LCS session IDs of the LCS sessions to be carried over LCS-UP connection 843A and the LCS session IDs of the LCS session to be carried over LCS-UP connection 843B may also be transmitted to the UE 832 in the respective NAS messages for setting up the connection, e.g., step 3 (430) of FIG. 4, or step 5 (550) of FIG. 5. In some aspects, the LCS session IDs may be signaled to the UE 832 together with the corresponding LMF ID. In some aspects, the signaling of the LCS session IDs may be carried out after the LMF received the confirmation for the UP connection establishment acknowledgement, e.g., step 6 (460) of FIG. 4 or step 8 (580) of FIG. 5. The signaling can use a specific SS signaling procedure over the control plane via the AMF to the UE. In some aspects, the LCS session IDs of the LCS session may be provided to the UE 832 by the corresponding LMF over the established LCS-UP connection).

There may be a change of LMF when the UE has established LCS-UP connection with two different LMFs. FIG. 8C is a diagram 850 illustrating an example structure with a UE 852, an AMF 854, a first LMF 856, a second LMF 858, and a third LMF 857, in accordance with various aspects of the present disclosure. As illustrated in FIG. 8C, the UE 852 may originally have an LCS-UP connection 863A with the first LMF 856 and an LCS-UP connection 863B with the second LMF 858. The first LMF 856 (e.g., a source LMF) or the AMF 854 may determine that a change of LMF may be performed and may accordingly perform steps in FIG. 7 to facilitate the LMF change. As an example, because the AMF 854 may be provided with information of the third LMF 857 as the target LMF in a response message from the second LMF 858, the AMF 854 may be aware of which LCS session(s) belongs to the context for the third LMF 857. Upon receiving message 867 from the third LMF 857 that includes UP information of the third LMF 857, the AMF 854 may transmit an NAS message 865 to the UE 852 to facilitate the LCS-UP connection to the third LMF 857. In some aspects, the NAS message 865 includes LCS session ID(s) to be replaced by new LCS sessions and the LCS session ID(s) of the new LCS sessions. In some aspects, the message 867 from the third LMF 857 that includes UP information of the third LMF 857 may be a request that also includes the LCS session ID(s) to be replaced, and the new LCS session IDs, and or the LMF ID of the second LMF 858 for verification by AMF 854.

In some aspects, the first LMF 856 may transfer context to either the third LMF 857 or the second LMF 858 (which already has LCS-UP connection 863B established). If the transfer is from the first LMF 856 to second LMF 858 (which already has an LCS-UP connection), an LCS-UP connection update procedure may be performed for the LMF 858. The third LMF 857 may indicate an update in a signaling to the AMF 854 after the LCS-UP connection with the UE 852 is established. The second LMF 858 may also indicate a LCS session ID(s) of the new LCS sessions to the UE to be added to UP context for the second LMF 858 over LCS-UP connection 863B (e.g., to add the LCS session ID(s) to the context of LCS-UP connection 863B on the UE 852). The signaling from the LMF 858 to the UE 852 may also indicate the old LCS sessions IDs to be removed from the LCS-UP connection 863A to the first LMF 856. In some aspects, the signaling from second LMF 858 may also indicate if the entire LCS-UP connection 863A to the first LMF 856 may be torn down.

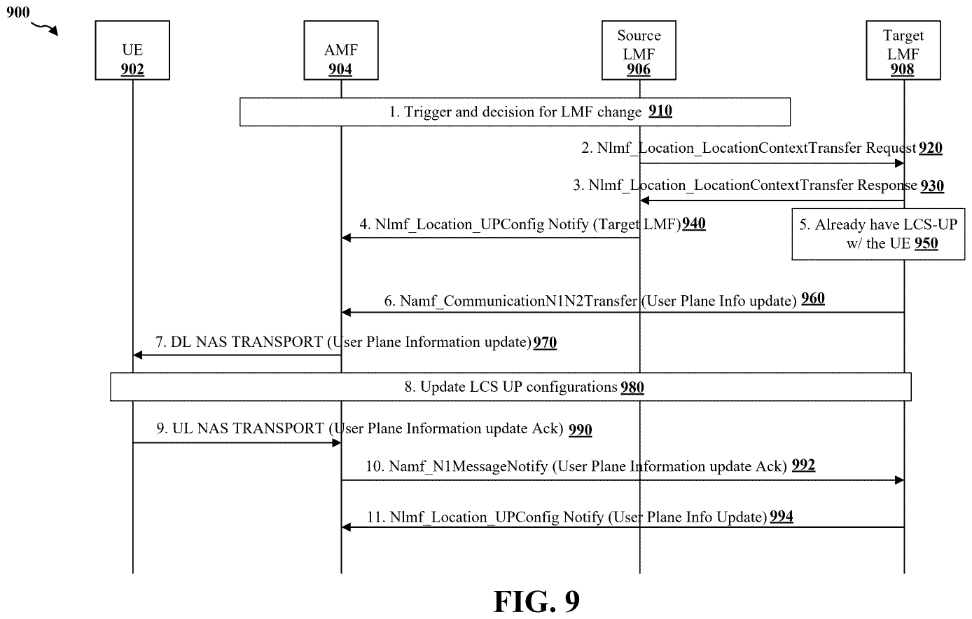

FIG. 9 is a diagram 900 illustrating example communications between a UE 902, an AMF 904, a source LMF 906, and a target LMF 908, in accordance with various aspects of the present disclosure. At 910, the AMF 904 or the source LMF 906 may determine to trigger LMF selection for the UE 902, which may be based on a notification message from the source LMF 906 or UE mobility associated with the UE 902 (e.g., while the UE is in a RRC connected mode or RRC idle mode). In some aspects, the AMF may also transmit a location configuration request (e.g., UP positioning connection configuration request) to the source LMF 906 to indicate a request for changing LMF for the UE 902. The source LMF 906 or the AMF 904 may determine the target LMF to be target LMF 908. After determining the target LMF 908, the source LMF 906 may transmit a UE context transfer request message 920 to the target LMF 908. The UE context transfer information may include session information, UE-specific data, positioning state, or other information related to the UE 902. The LMF change may be facilitated by the UE's change in mobility or based on the UE's UP event report.

Upon receiving the UE context transfer request message 920, the target LMF 908 may transmit a UE context transfer response message 930 to the source LMF 906 to indicate confirmation or rejection of the transfer. The source LMF 906 may transmit a location configuration response 940 to indicate information of the target LMF 908 (e.g., which may indicate an ID of the target LMF 708) and to indicate the AMF 904 to release context associated with the source LMF 906. At 950, the target LMF 908 may already have an LCS-UP connection with the UE 902. The AMF 904 may receive user plane information update 960 from the target LMF 908, which may include LCS session ID(s) that is transferred to the target LMF 908 from the source LMF 906.

The AMF 904 may forward the user plane information update 960 in a DL NAS message 970 to the UE 902. At 980, LCS UP configurations may be updated based on the user plane information update 960. The LCS UP configurations update at 980 may also trigger synchronization between the UE 902 and the source target LMF 908. The UE 902 may respond with an UL NAS message 990 to acknowledge the UP information update and replacement of the LCS session(s). The AMF 904 may notify the target LMF 908 at 992 to indicate that the UE 902 has acknowledged the UP information update and performed the replacement of the LCS session(s), and may receive a response at 994.

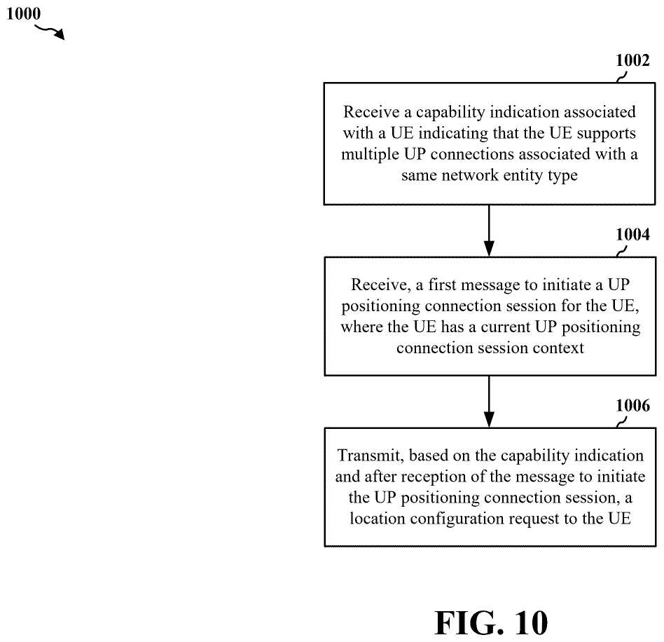

FIG. 10 is a flowchart 1000 of a method of wireless communication. The method may be performed by a network entity (e.g., the base station 102, the AMF 704, the AMF 804, the AMF 834, the AMF 854, the AMF 904, the network entity 1302, the network entity 1460). The method may facilitate management of multiple UP connections associated with a same type of network entity for a single UE, which may be an enhancement that improves positioning performance for the UE.

At 1002, the AMF may receive a capability indication associated with a UE indicating that the UE supports multiple UP connections associated with a same network entity type. For example, the AMF (e.g., 704 or 904) may receive a capability indication (e.g., before 710 or 910) associated with a UE (e.g., 702 or 902) indicating that the UE supports multiple UP connections (e.g., simultaneous) associated with a same network entity type. In some aspects, 1002 may be performed by connection component 199. In some aspects, the same network entity type is one of a LMF or a management function for an ISAC. In some aspects, the same network entity type is a management function for other types of non-data communication based services.

At 1004, the AMF may receive a first message to initiate a UP positioning connection session for the UE. For example, the AMF 704 may receive a message (e.g., in 750, 710, 910, or 940 or before 710 or 910) to initiate a UP positioning connection session for the UE. In some aspects, 1004 may be performed by connection component 199.

At 1006, the AMF may transmit, based on the capability indication and after reception of the first message to initiate the UP positioning connection session, a location configuration request (e.g., UP positioning connection configuration request) to the UE. For example, the AMF 704 may transmit, based on the capability indication and after reception of the first message to initiate the UP positioning connection session, a location configuration request (e.g., UP positioning connection configuration request) (e.g., in 760 or 970) to the UE. In some aspects, 1006 may be performed by connection component 199.

In some aspects, the AMF may receive, a second capability indication associated with a second UE indicating that the second UE does not support multiple UP connections associated with the same network entity type. The AMF may also receive a second message that includes a request for initiating a second UP positioning connection session, where the second UE has a current UP context. The AMF may transmit a rejection for the request for initiating the second UP positioning connection session for the second UE (e.g., based on the second UE does not support multiple UP connections associated with the same network entity type).

In some aspects, the AMF may receive, from a network entity (e.g., 750 or 940) associated with the same network entity type, UP information associated with the network entity. In some aspects, the AMF may transmit, to the UE, an NAS message (e.g., in 760 or 970) including the UP information associated with the network entity, where the NAS message includes a unique network entity ID associated with the network entity, and where the location configuration request corresponds to the NAS message. In some aspects, the unique network entity ID is included in a message together with the UP information associated with the network entity. In some aspects, the AMF may generate the unique network entity ID. In some aspects, the NAS message further includes one or more session IDs associated with the UP information associated with the network entity. In some aspects, the NAS message further includes one or more session IDs to be disassociated with a UP connection. In some aspects, additionally or alternatively, the NAS message may include routing information such as IP address, port, or security parameters associated with the network entity.

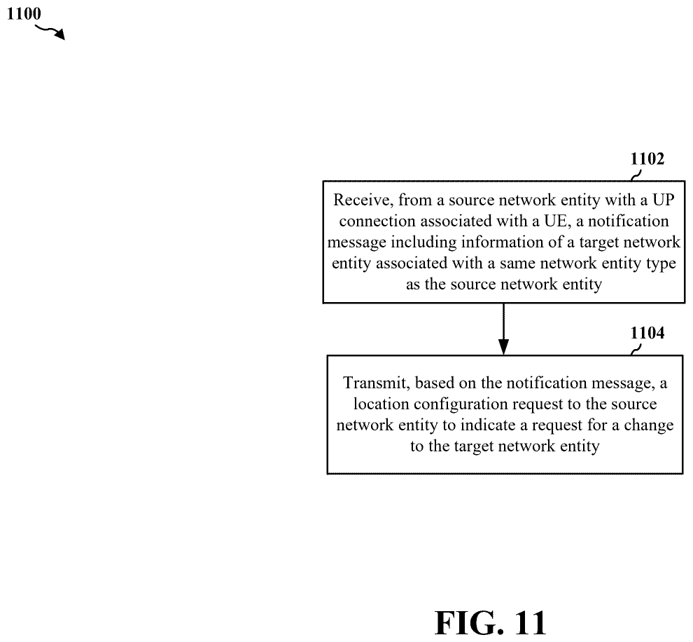

FIG. 11 is a flowchart 1100 of a method of wireless communication. The method may be performed by a network entity (e.g., the AMF 161, the AMF 704, the AMF 804, the AMF 834, the AMF 854, the AMF 904, the network entity 1302, the network entity 1460). The method may facilitate management of multiple UP connections associated with a same type of network entity for a single UE, which may be an enhancement that improves positioning performance for the UE.

At 1102, the AMF may receive, from a source network entity with a UP connection associated with a UE, a notification message including information of a target network entity associated with a same network entity type as the source network entity. For example, the AMF 904 may receive, from a source network entity (e.g., 906) with a UP connection associated with a UE (e.g., 902), a notification message (e.g., in 910 before 910) including information of a target network entity (e.g., 908) associated with a same network entity type as the source network entity. In some aspects, 1102 may be performed by connection component 199. In some aspects, the same network entity type is one of a LMF or a management function for an ISAC. In some aspects, the same network entity type is a management function for other types of non-data communication based services. In some aspects, the AMF may also trigger (e.g., at 910) a change (e.g., based on movement of the UE) associated with the source network entity.

At 1104, the AMF may transmit, based on the notification message, a location configuration request (e.g., UP positioning connection configuration request) to the source network entity to indicate a request for a change to the target network entity. For example, the AMF 904 may transmit, based on the notification message, a location configuration request (e.g., UP positioning connection configuration request) (e.g., at 910) to the source network entity to indicate a request for a change to the target network entity (e.g., 908). In some aspects, 1104 may be performed by connection component 199.

In some aspects, the AMF may reject, within a period of time associated with the target network entity, a UP connection establishment request to the UE from a second network entity (e.g., 808) different from the target network entity (e.g., 807 or 908), where the second network entity is associated with the same network entity type. In some aspects, the AMF may allow, after the period of time, the UP connection establishment request to the UE from the second network entity different from the target network entity. In some aspects, the AMF may transmit, after the period of time, a second location configuration request to the second network entity. In some aspects, the AMF may receive an indication of the period of time from the source network entity or determine the period of time. In some aspects, the AMF may allow a connection to the UE from the target network entity.

In some aspects, the AMF may receive, from the target network entity, UP information (e.g., in 960) associated with the target network entity. In some aspects, the AMF may transmit, to the UE, an NAS message (e.g., 970) including the UP information associated with the target network entity, where the NAS message includes a unique network entity ID associated with the target network entity.

In some aspects, the NAS message further includes a list of one or more session IDs associated with the target network entity. In some aspects, the NAS message further includes a second list of one or more IDs to be replaced by the list of one or more session IDs. In some aspects, a communication (e.g., 960) from the target network entity that includes the UP information further includes an network entity ID of a source network entity associated with the second list of one or more IDs. In some aspects, the unique network entity ID is included in a message together with the UP information associated with the target network entity. In some aspects, the AMF may generate the unique network entity ID. In some aspect the unique network entity ID is the LMF routing information. In some aspects, additionally or alternatively, the routing information may include such as IP address, port, or security parameters associated with the network entity.

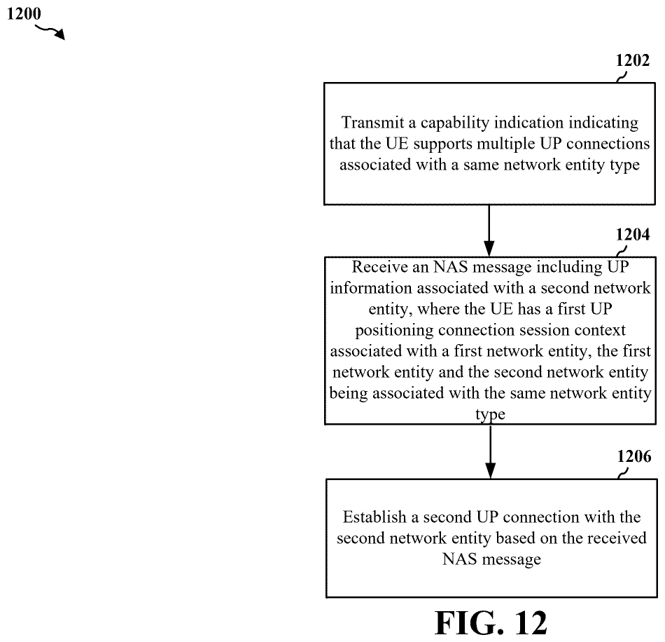

FIG. 12 is a flowchart 1200 of a method of wireless communication. The method may be performed by a UE (e.g., the UE 104, the UE 702, the UE 802, the UE 832, the UE 852, the UE 902; the apparatus 1304). The method may facilitate management of multiple UP connections associated with a same type of network entity for a single UE, which may be an enhancement that improves positioning performance for the UE.

At 1202, the UE may transmit a capability indication indicating that the UE supports multiple UP connections associated with a same network entity type. For example, the UE 902 may transmit a capability indication (e.g., before 910) indicating that the UE supports multiple UP connections (e.g., simultaneous) associated with a same network entity type. In some aspects, 1202 may be performed by connection component 198. In some aspects, the same network entity type is one of a location management function (LMF) or a management function for an ISAC. In some aspects, the same network entity type is a management function for other types of non-data communication based services.

At 1204, the UE may receive an NAS message including UP information associated with a second network entity, where the UE has a first UP positioning connection session context associated with a first network entity, the first network entity and the second network entity being associated with the same network entity type. For example, the UE (e.g., 832, 852, 902) may receive an NAS message (e.g., 845, 865, 970) including UP information associated with a second network entity, where the UE has a first UP positioning connection session context associated with a first network entity (e.g., 836, 858), the first network entity and the second network entity being associated with the same network entity type. In some aspects, 1204 may be performed by connection component 198. In some aspects, the NAS message includes a unique network entity identifier (ID) associated with the second network entity. In some aspects, the NAS message further includes a list of one or more session IDs associated with the second network entity. In some aspects, the NAS message further includes a second list of one or more session IDs (e.g., 863A) to be replaced by the list of one or more session IDs.

At 1206, the UE may establish a second UP connection with the second network entity based on the received NAS message. For example, the UE (e.g., 832, 852, 902) may establish a second UP connection with the second network entity (e.g., 838, 857) based on the received NAS message. In some aspects, 1206 may be performed by connection component 198.

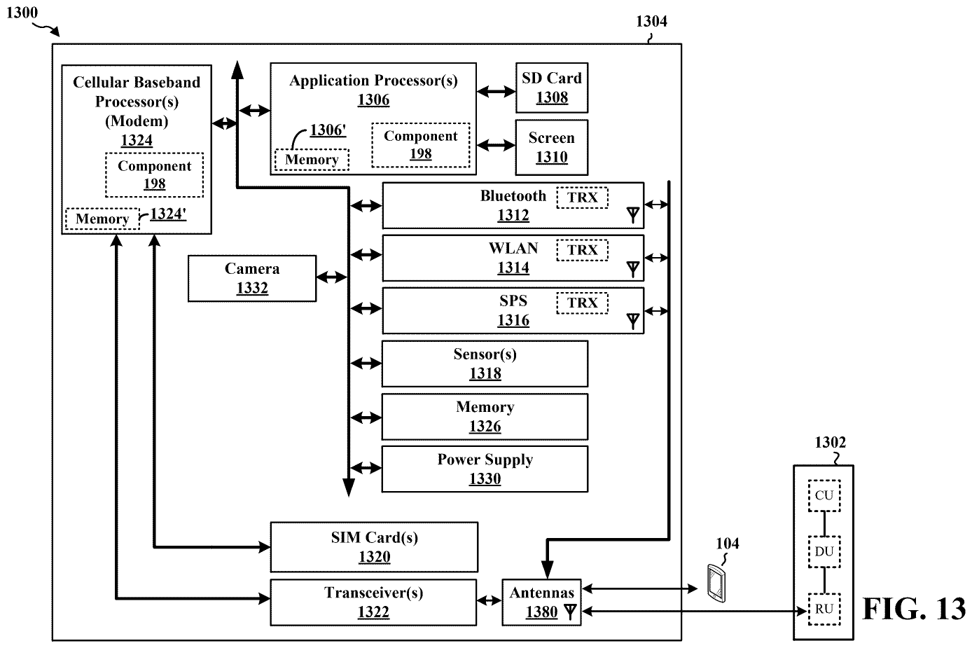

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the connection component 198 may be configured to transmit a capability indication indicating that the UE supports multiple UP connections associated with a same network entity type. In some aspects, the connection component 198 may be further configured to receive a non-access stratum (NAS) message including UP information associated with a second network entity, where the UE has a first UP positioning connection session context associated with a first network entity, the first network entity and the second network entity being associated with the same network entity type. In some aspects, the connection component 198 may be further configured to establish a second UP connection with the second network entity based on the received NAS message. The connection component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for transmitting a capability indication indicating that the UE supports multiple UP connections associated with a same network entity type. In some aspects, the apparatus 1304 may include means for receiving an NAS message including UP information associated with a second network entity, where the UE has a first UP positioning connection session context associated with a first network entity, the first network entity and the second network entity being associated with the same network entity type. In some aspects, the apparatus 1304 may include means for establishing a second UP connection with the second network entity based on the received NAS message. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

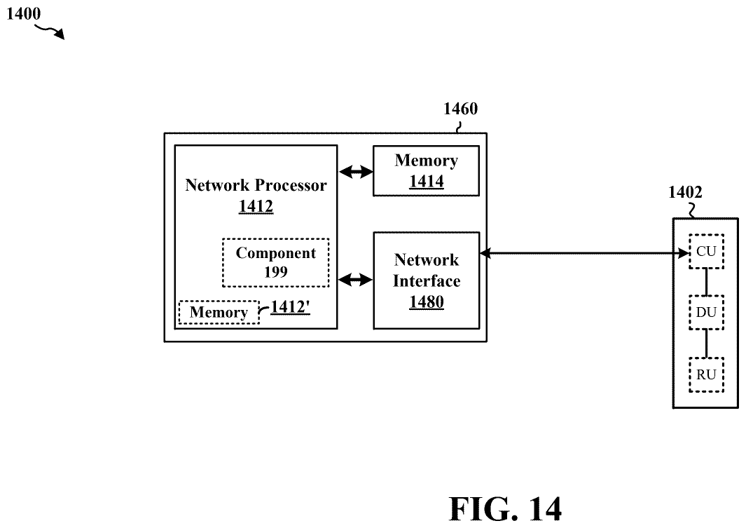

FIG. 14 is a diagram 1400 illustrating an example of a hardware implementation for a network entity 1460. In one example, the network entity 1460 may be within the core network 120. In some aspects, the network entity 1460 may be the AMF 161. The network entity 1460 may include at least one network processor 1412. The network processor(s) 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the connection component 199 may be configured to receive a capability indication associated with a UE indicating that the UE supports multiple UP connections associated with a same network entity type. In some aspects, the connection component 199 may be further configured to receive a first message to initiate a UP positioning session for the UE, where the UE has a current UP positioning session context. In some aspects, the connection component 199 may be further configured to transmit, based on the capability indication and after reception of the first message to initiate the UP positioning session, a location configuration request (e.g., UP positioning connection configuration request) to the UE. The component 199 may be within the network processor(s) 1412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for receiving a capability indication associated with a UE indicating that the UE supports multiple UP connections associated with a same network entity type. In some aspects, the network entity 1460 may include means for receiving a first message to initiate a UP positioning session for the UE, where the UE has a current UP positioning session context. In some aspects, the network entity 1460 may include means for transmitting, based on the capability indication and after reception of the first message to initiate the UP positioning session, a location configuration request (e.g., UP positioning connection configuration request) to the UE. In some aspects, the network entity 1460 may include means for receiving, a second capability indication associated with a second UE indicating that the UE does not support multiple UP connections associated with the same network entity type. In some aspects, the network entity 1460 may include means for receiving a second message that includes a request for initiating a second UP positioning session, where the second UE has a current UP context. In some aspects, the network entity 1460 may include means for transmitting a rejection for the request for initiating the second UP positioning session for the second UE. In some aspects, the network entity 1460 may include means for receiving, from a network entity associated with the same network entity type, UP information associated with the network entity. In some aspects, the network entity 1460 may include means for transmitting, to the UE, an NAS message including the UP information associated with the network entity, where the NAS message includes a unique network entity identifier (ID) associated with the network entity, and where the location configuration request corresponds to the NAS message. In some aspects, the network entity 1460 may include means for generating the unique network entity ID. In some aspects, the network entity 1460 may include means for receiving, from a source network entity with a UP connection associated with a UE, a notification message including information of a target network entity associated with a same network entity type as the source network entity. In some aspects, the network entity 1460 may include means for transmitting, based on the notification message, a location configuration request (e.g., UP positioning connection configuration request) to the source network entity to indicate a request for a change to the target network entity. In some aspects, the network entity 1460 may include means for triggering a change associated with the source network entity. In some aspects, the network entity 1460 may include means for rejecting, within a period of time associated with the target network entity, a UP connection establishment request to the UE from a second network entity different from the target network entity, where the second network entity is associated with the same network entity type. In some aspects, the network entity 1460 may include means for allowing, after the period of time, the UP connection establishment request to the UE from the second network entity different from the target network entity. In some aspects, the network entity 1460 may include means for transmitting, after the period of time, a second location configuration request to the second network entity. In some aspects, the network entity 1460 may include means for receiving an indication of the period of time from the network source entity or determine the period of time. In some aspects, the network entity 1460 may include means for allowing a connection to the UE from the target network entity. In some aspects, the network entity 1460 may include means for receiving, from the target network entity, UP information associated with the target network entity. In some aspects, the network entity 1460 may include means for transmitting, to the UE, an NAS message including the UP information associated with the target network entity, where the NAS message includes a unique network entity identifier (ID) associated with the target network entity. In some aspects, the network entity 1460 may include means for generating the unique network entity ID. The means may be the component 199 of the network entity 1460 configured to perform the functions recited by the means. The network entity 1460 may be further configured to perform any of the aspects in FIG. 10 or FIG. 11 and performed by the AMF 161, the AMF 704, the AMF 804, the AMF 834, the AMF 854, or the AMF 904.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is an apparatus for wireless communication at an access and mobility management function (AMF), including: at least one memory; and at least one processor coupled to the at least one memory, based at least in part on information stored in the at least one memory, the at least one processor is configured to: receive a capability indication associated with a user equipment (UE) indicating that the UE supports multiple user plane (UP) connections associated with a same network entity type; receive a first message to initiate a UP positioning connection session for the UE, where the UE has a current UP positioning connection session context; and transmit, based on the capability indication and after reception of the first message to initiate the UP positioning connection session, a location configuration request (e.g., UP positioning connection configuration request) to the UE.

Aspect 2 is the apparatus of aspect 1, where the same network entity type is one of a location management function (LMF) or a management function for an integrated sensing and communication (ISAC), and where the at least one processor is further configured to: receive, a second capability indication associated with a second UE indicating that the second UE does not support multiple UP connections associated with the same network entity type; receive a second message that includes a request for initiating a second UP positioning connection session, where the second UE has a current UP context; and transmit a rejection for the request for initiating the second UP positioning connection session for the second UE.

Aspect 3 is the apparatus of any of aspects 1-2, where the at least one processor is further configured to: receive, from a network entity associated with the same network entity type, UP information associated with the network entity; and transmit, to the UE, a non-access stratum (NAS) message including the UP information associated with the network entity, where the NAS message includes routing information associated with the network entity, and where the location configuration request corresponds to the NAS message.

Aspect 4 is the apparatus of aspect 3, where the routing information comprises an IP address and a port associated with the network entity.

Aspect 5 is the apparatus of any of aspects 3-4, where the at least one processor is further configured to: generate a unique network entity ID associated with the network entity.

Aspect 6 is the apparatus of aspect 5, where the NAS message further includes one or more LCS session IDs associated with the UP information associated with the network entity.

Aspect 7 is the apparatus of any of aspects 5-6, where the NAS message further includes one or more LCS session IDs to be disassociated with a UP connection.

Aspect 8 is an apparatus for wireless communication at an access and mobility management function (AMF), including: at least one memory; and at least one processor coupled to the at least one memory, based at least in part on information stored in the at least one memory, the at least one processor is configured to: receive, from a source network entity with a user plane (UP) connection associated with a user equipment (UE), a notification message including information of a target network entity associated with a same network entity type as the source network entity; and transmit, based on the notification message, a location configuration request (e.g., UP positioning connection configuration request) to the source network entity to indicate a request for a change to the target network entity.

Aspect 9 is the apparatus of aspect 8, where the same network entity type is one of a location management function (LMF) or a management function for an integrated sensing and communication (ISAC), and where the at least one processor is further configured to: trigger the change associated with the source network entity.

Aspect 10 is the apparatus of any of aspects 8-9, where the at least one processor is further configured to: reject, within a period of time associated with the target network entity, a UP connection establishment request to the UE from a second network entity different from the target network entity, where the second network entity is associated with the same network entity type.

Aspect 11 is the apparatus of aspect 10, where the at least one processor is further configured to: allow, after the period of time, the UP connection establishment request to the UE from the second network entity different from the target network entity.

Aspect 12 is the apparatus of any of aspects 10-11, where the at least one processor is further configured to: transmit, after the period of time, a second location configuration request to the second network entity.

Aspect 13 is the apparatus of any of aspects 10-12, where the at least one processor is further configured to: receive an indication of the period of time from the network source entity or determine the period of time.

Aspect 14 is the apparatus of any of aspects 9-13, where the at least one processor is further configured to: allow a connection to the UE from the target network entity.

Aspect 15 is the apparatus of any of aspects 9-14, where the at least one processor is further configured to: receive, from the target network entity, UP information associated with the target network entity; and transmit, to the UE, a non-access stratum (NAS) message including the UP information associated with the target network entity, where the NAS message includes routing information associated with the target network entity.

Aspect 16 is the apparatus of aspect 15, where the NAS message further includes a list of one or more LCS session IDs associated with the target network entity.

Aspect 17 is the apparatus of aspect 16, wherein the NAS message further comprises a second list of one or more IDs to be replaced by the list of one or more LCS session IDs, and wherein a communication from the target network entity that comprises the UP information further comprises an network entity ID of the source network entity.

Aspect 18 is the apparatus of aspect 17, where the at least one processor is further configured to receive, from the target network entity, a user plane (UP) connection modification message comprising routing information associated with the source network entity; and transmit, to the UE, a second NAS message comprising the UP connection modification message and second routing information associated with the target network entity, such that the UE receives both the routing information associated with the source network entity and the second routing information associated with the target network entity.

Aspect 19 is the apparatus of any of aspects 15-18, where the unique network entity ID is included in a message together with the UP information associated with the target network entity.

Aspect 20 is the apparatus of any of aspects 15-19, where the at least one processor is further configured to: generate the unique network entity ID.

Aspect 21 is an apparatus for wireless communication at a user equipment (UE), including: at least one memory; and at least one processor coupled to the at least one memory, based at least in part on information stored in the at least one memory, the at least one processor is configured to: transmit a capability indication indicating that the UE supports multiple user plane (UP) connections associated with a same network entity type; receive a non-access stratum (NAS) message including UP information associated with a second network entity, where the UE has a first UP positioning connection session context associated with a first network entity, the first network entity and the second network entity being associated with the same network entity type; and establish a second UP connection with the second network entity based on the received NAS message.

Aspect 22 is the apparatus of aspect 21, where the NAS message includes routing information associated with the second network entity.

Aspect 23 is the apparatus of aspect 22, where the NAS message further includes a list of one or more LCS session IDs associated with the second network entity.

Aspect 24 is the apparatus of aspect 23, where the NAS message further includes a second list of one or more session IDs to be replaced by the list of one or more session IDs.

Aspect 25 is the apparatus of aspects 22-24, where the same network entity type is one of a location management function (LMF) or a management function for an integrated sensing and communication (ISAC).

Aspect 26 is a method of wireless communication for implementing any of aspects 1 to 20.

Aspect 27 is a computer-readable medium (e.g., a non-transitory computer-readable medium) storing computer executable code, the code when executed by at least one processor causes the at least one processor to implement any of aspects 1 to 20.

Aspect 28 is an apparatus comprising means for implementing any of aspects 1 to 20.

Aspect 29 is a method of wireless communication for implementing any of aspects 21 to 25.

Aspect 30 is a computer-readable medium (e.g., a non-transitory computer-readable medium) storing computer executable code, the code when executed by at least one processor causes the at least one processor to implement any of aspects 21 to 25.

Aspect 31 is an apparatus comprising means for implementing any of aspects 21 to 25.

What is claimed is:

1. An apparatus for wireless communication at an access and mobility management function (AMF), comprising:
at least one memory; and
at least one processor coupled to the at least one memory, based at least in part on information stored in the at least one memory, the at least one processor is configured to:
receive a capability indication associated with a user equipment (UE) indicating that the UE supports multiple user plane (UP) connections associated with a same network entity type;
receive a first message to initiate a UP positioning connection session for the UE, wherein the UE has a current UP positioning connection session context; and
transmit, based on the capability indication and after reception of the first message to initiate the UP positioning connection session, a UP positioning connection configuration request to the UE.

2. The apparatus of claim 1, wherein the at least one processor is further configured to:
receive, a second capability indication associated with a second UE indicating that the second UE does not support multiple UP connections associated with the same network entity type;
receive a second message that includes a request for initiating a second UP positioning connection session, wherein the second UE has a current UP context; and
transmit a rejection for the request for initiating the second UP positioning connection session for the second UE.

3. The apparatus of claim 1, wherein the at least one processor is further configured to:
receive, from a network entity associated with the same network entity type, UP information associated with the network entity; and
transmit, to the UE, a non-access stratum (NAS) message comprising the UP information associated with the network entity, wherein the NAS message comprises routing information associated with the network entity, and wherein the UP positioning connection configuration request corresponds to the NAS message.

4. The apparatus of claim 3, wherein the routing information is included in the UP positioning connection configuration request carrying the UP information associated with the network entity.

5. The apparatus of claim 4, wherein the NAS message further comprises one or more location service (LCS) session IDs associated with the UP information associated with the network entity.

6. The apparatus of claim 4, wherein the NAS message further comprises one or more location service (LCS) session IDs to be disassociated with a UP connection.

7. The apparatus of claim 3, wherein the routing information comprises an Internet protocol (IP) address and a port.

8. An apparatus for wireless communication at an access and mobility management function (AMF), comprising:
at least one memory; and
at least one processor coupled to the at least one memory, based at least in part on stored information that is stored in the at least one memory, the at least one processor is configured to:
receive, from a source network entity with a user plane (UP) connection associated with a user equipment (UE), a notification message comprising information of a target network entity associated with a same network entity type as the source network entity; and
transmit, based on the notification message, a UP positioning connection configuration request to the source network entity to indicate a request for a change to the target network entity.

9. The apparatus of claim 8, wherein the at least one processor is further configured to:
trigger the change associated with the source network entity.

10. The apparatus of claim 8, wherein the at least one processor is further configured to:
reject, within a period of time associated with the target network entity, a UP connection establishment request to the UE from a second network entity different from the target network entity, wherein the second network entity is associated with the same network entity type.

11. The apparatus of claim 10, wherein the at least one processor is further configured to:
allow, after the period of time, the UP connection establishment request to the UE from the second network entity different from the target network entity.

12. The apparatus of claim 10, wherein the at least one processor is further configured to:
transmit, after the period of time, a second location configuration request to the second network entity.

13. The apparatus of claim 10, wherein the at least one processor is further configured to:
receive an indication of the period of time from the source network entity or determine the period of time.

14. The apparatus of claim 9, wherein the at least one processor is further configured to:
allow a connection to the UE from the target network entity.

15. The apparatus of claim 9, wherein the at least one processor is further configured to:
receive, from the target network entity, UP information associated with the target network entity; and
transmit, to the UE, a non-access stratum (NAS) message comprising the UP information associated with the target network entity, wherein the NAS message comprises a routing information associated with the target network entity.

16. The apparatus of claim 15, wherein the NAS message further comprises a list of one or more location service (LCS) session IDs associated with the target network entity.

17. The apparatus of claim 16, wherein the NAS message further comprises a second list of one or more IDs to be replaced by the list of one or more LCS session IDs, and wherein a communication from the target network entity that comprises the UP information further comprises an network entity ID of the source network entity.

18. The apparatus of claim 17, wherein the at least one processor is further configured to:
receive, from the target network entity, a user plane (UP) connection modification message comprising routing information associated with the source network entity; and
transmit, to the UE, a second NAS message comprising the UP connection modification message and second routing information associated with the target network entity.

19. The apparatus of claim 15, wherein the routing information is included in a message together with the UP information associated with the target network entity.

20. An apparatus for wireless communication at a user equipment (UE), comprising:
at least one memory; and
at least one processor coupled to the at least one memory, based at least in part on information stored in the at least one memory, the at least one processor is configured to:
transmit a capability indication indicating that the UE supports multiple user plane (UP) connections associated with a same network entity type;
receive a non-access stratum (NAS) message comprising UP information associated with a second network entity, wherein the UE has a first UP positioning connection session context associated with a first network entity, the first network entity and the second network entity being associated with the same network entity type; and
establish a second UP connection with the second network entity based on the received NAS message.
